(19) United States
(12) Patent Application Publication
(10) Pub. No.: US 2026/0104923 A1
(43) Pub. Date: Apr. 16, 2026

(54) Thread Scheduling Based on Performance Characteristics

(71) Applicant: Google LLC, Mountain View, CA (US)

(72) Inventors: Donny YI, San Diego, CA (US); Hee Jun PARK, San Diego, CA (US)

(21) Appl. No.: 18/912,999

(22) Filed: Oct. 11, 2024

(51) Int. Cl. G06F 9/48; G06F 11/34

(52) U.S. Cl. CPC G06F 9/4887; G06F 11/3433

(57) ABSTRACT

Methods and systems, including computational instructions/programs encoded on computer-readable media, are described for dynamically allocation thread execution tasks based on performance characteristics. The system includes multiple processing cores, a hardware lookup table, and at least one processing core configured to execute operations that include receiving a request to perform a classification process for a thread to be executed on the multiple processing cores and scheduling execution of the thread on the first processing core for a first time period. After the execution of the thread for the first time period, the at least one processing core is configured to obtain a value of a performance metric for the execution of the thread on the first processing core, and to store the one or more predicted thread characteristics in the hardware lookup table.

### BACKGROUND

This specification generally relates to scheduling threads to be executed across multiple processors.

Computing systems, which can include an operating system implemented on multi-core processors, can implement operations that involve thread scheduling, in which threads, the smallest unit of processing that can be executed by a processor, are assigned to be executed across multiple processor cores of a multi-core processor. In some instances, the computing system includes more threads ready to be executed than available compute resources, e.g., processing cores. In these instances, a thread scheduler determines which thread should run at any given time on each processing core.

In some cases, the thread scheduler can interrupt an execution of a thread on a first processing core to complete execution on a second processing core. In some cases, the thread scheduler executes a default thread scheduling algorithm, e.g., first come first serve, round robin, or priority scheduling. In some cases, the thread scheduler can implement frequency/utilization based scheduling, which in some cases does not accurately describe computational requirements of a workload. In some cases, a thread scheduler schedules threads for execution based on a dynamic voltage and frequency scaling (DVFS) policy, which is a policy for adjusting voltage and frequency of a processor dynamically based on a current workload and/or a power management objective.

### SUMMARY

Computing systems that execute tasks related to a thread can include multiple processors. In some cases, subsets of tasks, e.g., tasks related to a machine learning workload, can be allocated to one or more processors depending on the nature of the tasks and characteristics of each processor. In some cases, characteristics of a particular processor make the processor more suitable for a particular type of task in comparison with a different type of task. For example, a first processor of a multi-processor system can have different capabilities in comparison with a second processor of the same system. For example, the first processor can have more registers, more execution units, higher processing frequency, or access to more memory. As described in this document, a classifier model (a trained machine learning model) can output thread characteristics based on performance metrics to determine if a thread is optimally scheduled on a processor in comparison with other processors of a system.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

Particular embodiments of the subject matter described in this specification can be implemented as to realize one or more of the following advantages. By monitoring performance metrics of a processor in relation to an execution of a thread and determining an optimal processor to execute the thread based on the performance metrics, the technique enables faster and more optimal thread scheduling decisions. Optimal thread scheduling decisions allow for more reduced energy consumption and improved resource allocation by avoiding an over allocation of compute resources for threads that do not benefit from high performance processors (higher energy consumption) in comparison with lower performance processors (lower energy consumption).

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system for scheduling threads.

FIG. 2 illustrates an example system for performing a thread classification.

FIG. 3 illustrates an example timeline of thread execution that includes thread classification.

FIG. 4 illustrates an example thread scheduling implementation.

FIG. 5 illustrates an example system for scheduling threads.

FIG. 6 is a flow diagram of an example process for performing a thread classification.

FIG. 7 is a flow diagram of an example process for scheduling threads.

FIG. 8 is an example graphical representation of computational scaling characteristics of threads.

Like reference numbers and designations in the various drawings indicate like elements.

### DETAILED DESCRIPTION

This specification generally relates to computing systems that leverage performance metrics to dynamically schedule thread operations between different processors of such systems. The system populates a lookup table with predicted thread characteristics based on processed performance metrics. Based on the stored predicted thread characteristics, the system dynamically schedules thread operations.

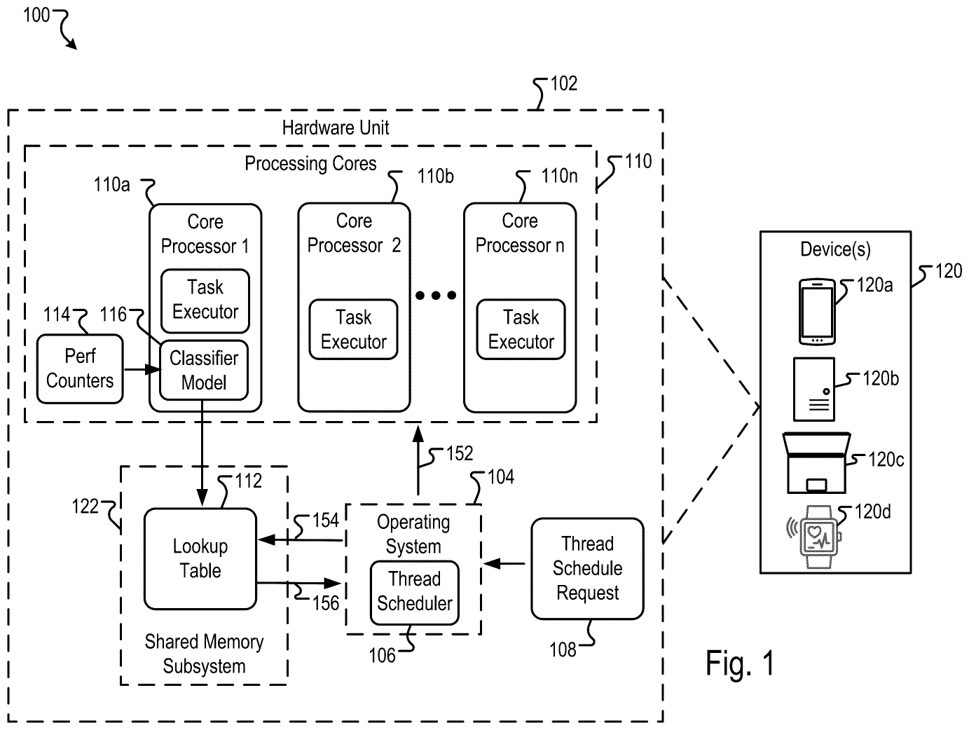

As summarized here and described below in greater detail with reference to FIGS. 1-8, a computing system can be configured to process a particular task workload (e.g., a machine learning (ML) workload) using multiple processing units—e.g., a processing core of a multi-core processor—deployed in such systems. Threads are units of processing operations that can be scheduled for execution on a processor by an operating system. In some cases, threads exist within larger processes and share the process's compute and memory resources. A process, e.g., operations associated with a computer program like a web browser or ML workload, can be split into multiple threads, in which each thread can include a subset of operations included in the larger process. Various techniques for efficiently executing thread operations can be implemented, including parallel thread execution between multiple processors, concurrent thread execution by a single processor, and other thread scheduling strategies (e.g., first come first serve, priority scheduling, shortest job next, etc.).

A processor can be configured to process particular types of workloads, such as, e.g., ML workloads that involve matrix processing operations. In some cases, processors are characterized by a size and/or performance attribute, e.g., little, middle, and big, which can refer to compute throughput or other capacity metrics. In some cases, a particular thread is better suited for execution on a first processor with a particular set of characteristics in comparison with a second processor with a different particular set of characteristics. In some cases, a particular thread does not scale as the size of a processor increases. In other words, the system does not observe a performance gain by executing a particular thread on a larger processor. Therefore, a smaller processor can be selected without a performance tradeoff while benefiting from less energy consumption and more available throughput on a larger processor to be used for threads that can benefit from the characteristics of the larger processor. Example processor characteristics that can differentiate between the first processor and the second processor include number of registers, number of execution units, clock speed (e.g., a number of instructions executed per second), cache size, and memory bandwidth.

In some cases, a default thread scheduler distributes threads across multiple processors. The systems and methods described in this specification describe an adaptive strategy for evaluating computational performance during an execution of a particular thread on a particular processor and facilitating an adaptive re-scheduling of the thread to a more suitable processor based on measured performance metrics.

More than one processor can be configured to process the same (or similar) workloads. As an illustrative example, a first processor can perform better than a second processor when confronted with workloads, e.g., threads, that require a low data access rate and high compute rate, whereas the second processor can perform better than the first processor for processing workloads that have relatively higher memory bandwidth and energy consumption needs. For ease of description and brevity, the following description is provided in the context of allocating workloads between multiple processors, in which each processor can demonstrate particular computational performance metrics. However, these techniques are also applicable to any type of processor and any type of workloads (e.g., workloads including ML workloads and non-ML workloads) that the processors may be specifically configured to process. In addition, the described dynamic allocation of threads related to a workload need not be limited to an allocation between two processors (e.g., may be allocated between more than two processors).

In some cases, tasks of a first workload are better suited to be executed by a first type of processor in comparison with a second type of processor. The ability to dynamically determine an optimal processor for executing a particular workload allows for more optimal scheduling decisions in comparison with static and/or pre-determined default scheduling protocols. Because of this, a number of workload types can benefit from dynamic thread scheduling based on performance characteristics. For example, throughput-sensitive workloads such as video editing and/or rendering benefit from high performance computing cores that are optimized for maximal throughput (e.g., an amount of work that is completed in a unit of time). Throughput-sensitive workloads are often associated with sustained workloads.

As another example, latency-sensitive workloads such as web browsing and/or user interface operations benefit from processing cores that are tuned to provide a low latency response (e.g., cores that are tuned to process shorter bursts of activity).

As a further example, workloads that scale with frequency and/or power such as CPU-bound gaming benefit from larger processing cores (e.g., processing cores with higher frequency and/or power limits). In some cases, heterogeneous systems include cores that are distinguished from each other by various maximum frequency and/or power limits. In the case that workload does not scale with frequency and/or power, the workload does not benefit from being executed on a processing core with higher frequency and/or power.

As a further example, workloads can benefit from particular architectural features of particular processing cores. Architectural features can include structural depth, width, and number of compute units. Processors can have different combinations of architectural features, and because of this, different processing capabilities. For example, higher floating point resolution is achieved by processors with larger and more floating-point unit (FPU) execution units. Applications such as scientific and physics applications can benefit from higher floating point capabilities.

As a further example, workloads can be designed to adhere to system policy settings in which user defines one or more system requirements like performance and/or power characteristics. In these cases, the system can execute workloads on particular processing cores to maximize efficiency based on the system policy settings.

In the example use case of tasks related to a particular workload that may be processed by a computing system having at least a first processor and a second processor (e.g., a big processor and a small processor), the computing system can include processing logic that estimates each processing unit's operational characteristics or parameters (e.g., execution time, energy consumption, frequency, etc.) for processing threads. A default thread scheduler can consider the operational characteristics and distribute a set of threads to be executed on each processor.

In some cases, the thread scheduler can implement frequency/utilization based scheduling, which in some cases does not accurately describe computational requirements of a workload. For example, a spinlock thread that does not require execution of payload operations requires a similar execution frequency and utilization characteristics as a thread that requires a large number of payload operations, e.g., a video game render thread. In some cases, hardware metrics are recorded and stored at a per-core level instead of at a per-thread level. The systems and method described in this specification take advantage of per-thread characteristic monitoring. Thread characteristics include workload (e.g., clock cycles) and inter-process communication (IPC), among others.

The thread scheduler can process performance metrics of a processor as it executes tasks of a particular thread, and dynamically determine an optimal processor for further execution. At runtime, an initial set of tasks associated with a thread can be executed by the first processor per the thread scheduler's initial allocation of threads. As the first processor executes the initial allocation of tasks, the processor can record one or more performance metrics accessible to the thread scheduler. In some cases, the logic implemented by the thread scheduler can re-allocate a remaining subset of tasks of the thread to the second processor based on the realized runtime performance metrics. In other words, the thread scheduler processes the performance metrics and/or derived metrics from a classification operation and determines the second processor to be more suitable for the thread execution in comparison with the first processor.

These and additional features are described below with reference to FIGS. 1-8.

FIG. 1 is a block diagram of an example computing system 100 for scheduling threads. The system 100 includes a hardware unit 102. In some implementations, the hardware unit 102 is part of a device 120, e.g., a mobile telephone/tablet 120a, a server 120b, a desktop/laptop computer 120c, or wearable device 120d. The device 120 executes processes in relation to programs and applications running on the device 120. Each process includes multiple tasks (e.g., computations associated with an application, data processing pipeline, etc.), that are executed by one or more processing cores 110. Some devices include multiple processors, e.g., processor 110a-110n, in which each processor 110a-110n can execute tasks associated with a thread.

In the example computing system 100, the hardware unit 102 is integrated in, or accessible by, an example computing device 120, such as a consumer electronic device or mobile/client device. In some implementations, computing device 120 is represented by example items such as tablets, laptops, Chromebooks, eNotebooks, Netbooks, or other related mobile computers. In some implementations, the hardware unit 102 is accessed using a desktop computer, network server, or related cloud-based asset.

The hardware unit 102 includes hardware resources for executing operations associated with an operating system 104 that includes a capability of executing logic associated with a thread scheduler 106. As illustrated in FIG. 1, the hardware resources include the processors 110a-n. The operating system 104 can receive a thread schedule request 108 from a software application/program implemented on the device 120. The thread scheduler 106 can implement a default thread scheduling protocol, in which the thread received in relation to the thread schedule request 108, is scheduled to be executed on a particular processor of the multiple processing cores 110 (e.g., processor 110b). A data path 152 between the operating system 104 and a processor of the multiple processors 110 facilitates a transmission of data indicative of the thread to be scheduled.

In order to identify predicted characteristics of a thread, one of the processors (e.g., processor 110b) processes a first set of tasks of the thread with a corresponding task executor. As the first set of tasks are executed or after the first set of tasks are executed, the processor updates one or more performance counters 114. In some implementations, multiple performance counters, each having values stored as register values in the hardware unit 102, count a number of events associated with a processor of the processors 110. For example, the hardware unit 102 can include performance counters 114 that count a percentage of processor time used for executing threads, a processor queue length (e.g., a number of threads waiting for processing), disk read bytes per second, and bytes received per second) for each processor.

A classifier model 116 is executed on a processor of the hardware unit 102. The classifier model 116 is a trained machine learning model, e.g., a trained neural network. In some implementations, a dedicated processor executes operations associated with the classifier model 116 along with other tasks, e.g., thread execution. In some other implementations, the classifier model 116 is implemented on multiple processors of the hardware unit 102. The classifier model 116 processes values of the performance counters 114. In some implementations, the classifier model 116 is a predictive model (e.g., a trained neural network), that processes the performance counter 114 values and outputs one or more thread characteristics (i.e., thread characteristics). The thread characteristics are indicative of a performance evaluation of a particular processor executing instructions of a particular thread. For example, based on multiple values represented by values of the performance counters 114, the classifier model 116 can output a predicted classification value indicative of frequency sensitivity or scalability. The output of the classifier model 116 can be indicative of a thread that is sub-optimally or optimally scheduled to execute on a particular processor.

The hardware unit 102 stores the output values of the classifier model 116 in a hardware lookup table 112. The hardware lookup table 112 is stored in a shared memory subsystem 122. The shared memory subsystem 122 is accessible to the operating system 104 and to at least one processor of the processing cores 110. In some implementations, the shared memory subsystem 122 is implemented as an SRAM device.

An application executed as part of the operating system 104, e.g., the thread scheduler 106, can issue a query 154 to the hardware lookup table 112 to determine a classification output associated with a particular thread execution. The thread scheduler 106 is a program executed by the operating system 104 to implement a thread scheduling algorithm. In some cases, the thread scheduler 106 determines a processor to execute instructions of each thread. Standard thread scheduler programs include first-in-first-out, priority scheduling, and others. In some cases, the particular thread is a thread scheduled to be executed on a particular processor by the thread scheduler 106. The thread scheduler 106 can receive a query result 156 that is indicative of a thread class in relation to the particular thread and the particular processor.

In some implementations, the hardware lookup table 112 is represented by a hardware table size large enough to maintain and store useful context but small enough to reduce lookup time and lookup complexity. Data replacement schemes like time-based replacement and/or least recently used (LRU) replacement provide control over the size of the hardware lookup table 112.

In some cases, the thread scheduler 106 receives the query result 156 before the particular processor completes the execution of the particular thread tasks. The thread scheduler 106 can determine, based on the query result 156, that the particular thread is more suitable for execution on a different processor. The operating system 104 can issue a command through the data path 152 to interrupt the execution of the thread tasks and re-allocate the remaining thread tasks to the different processor. In some other cases, the thread scheduler 106 can optimally schedule remaining tasks of the thread to be executed on the different processor for subsequent instantiations.

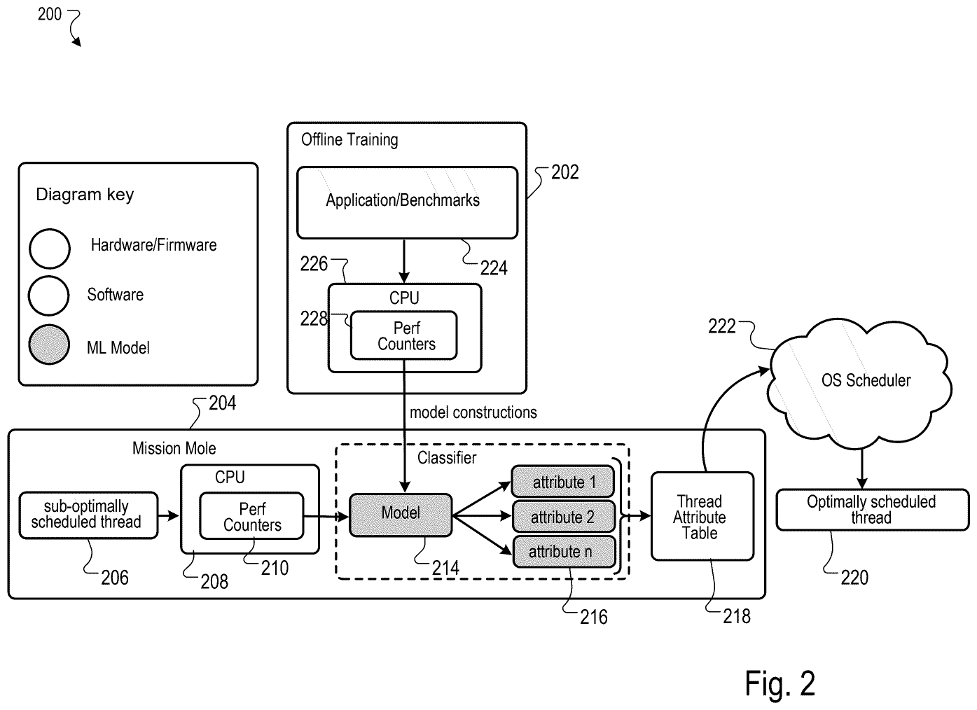

FIG. 2 illustrates an example system 200 for performing a thread classification. The system 200 includes a representation of training operations 202 and a representation of scheduling operations 204. The training operations 202 include operations for training a classifier model 214, as described in relation to the classifier model 116.

The classifier model 214 processes one or more values stored as performance counters 210 in relation to a processor 208 executing tasks of a particular thread. The classifier model 214 outputs one or more thread characteristics 216 that are stored in a hardware lookup table 218, e.g., a thread characteristic table or a lookup table. In some implementations, each row of the hardware lookup table 218 includes a thread identifier and multiple values that each correspond to a thread characteristic, e.g., an output of the classifier model 214.

The training operations 202 include execution of processes associated with applications and/or benchmark applications 224. The processes associated with the applications 224 are executed on a processor 226. In some implementations, the processor 226 includes multiple processors of various sizes. Performance counters 228 associated with the processor 226 (or processors) record performance metrics associated with the processor 226 and threads that are scheduled to execute on the processor 226, in which the threads are associated with the particular programs/operations of the applications 224.

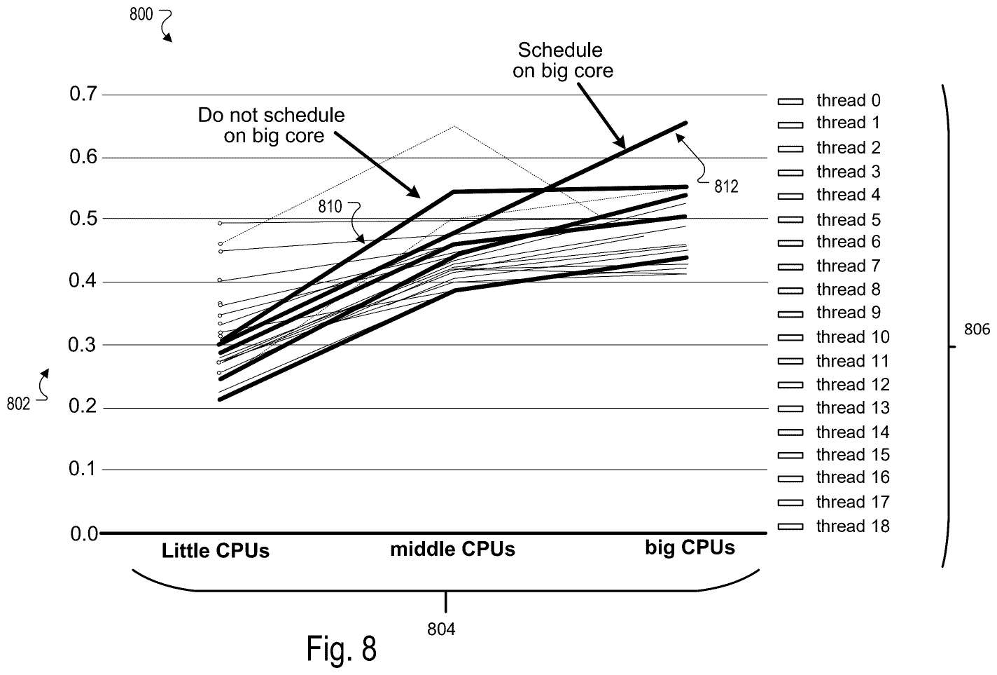

In some implementations, thread operations associated with the applications 224 are executed by multiple processors of different sizes to determine if the thread operations scale with processor size. The scalability of a thread-processor pair is further described in relation to the description of FIG. 8. A classifier model is trained using training data that includes input thread characteristics of the applications 224 and performance analysis of the execution of the associated threads.

The representation of scheduling operations 204 illustrates a particular example of a sub-optimally schedule thread 206. In some implementations, an operating system schedules the thread 206 to be executed by a particular processor based on a default thread scheduling policy. In some cases, the particular processor is not an optimal processor for executing the instructions contained within the thread 206.

The processor 208 receives the thread 206 and executes a first subset of tasks of the thread 206 for a first time period. During or after execution, the processor 208 updates performance counters 210 to monitor one or more performance metrics in relation to the execution of the thread 206. As execution progresses or completes, the classifier model 214 receives and processes values of the performance counters 210. The classifier model 214 generates one or more characteristics 216 indicative of one or more classifications of the thread 206. The processor implementing the classifier model 214 executes instructions to store the one or more characteristics 216 in the hardware lookup table 218.

The thread characteristics stored in the hardware lookup table 218 are accessible to an operating system, and in particular to a thread scheduler 222 implemented on the operating system. Based on the characteristics 216 received from the hardware lookup table 218, the thread scheduler 222 can determine an optimally scheduled thread 220 (e.g., an optimally scheduled thread is a thread schedule to be executed using an optimally-sized processor). In some cases, the optimally scheduled thread 220 is executed on a processor different from the processor 208.

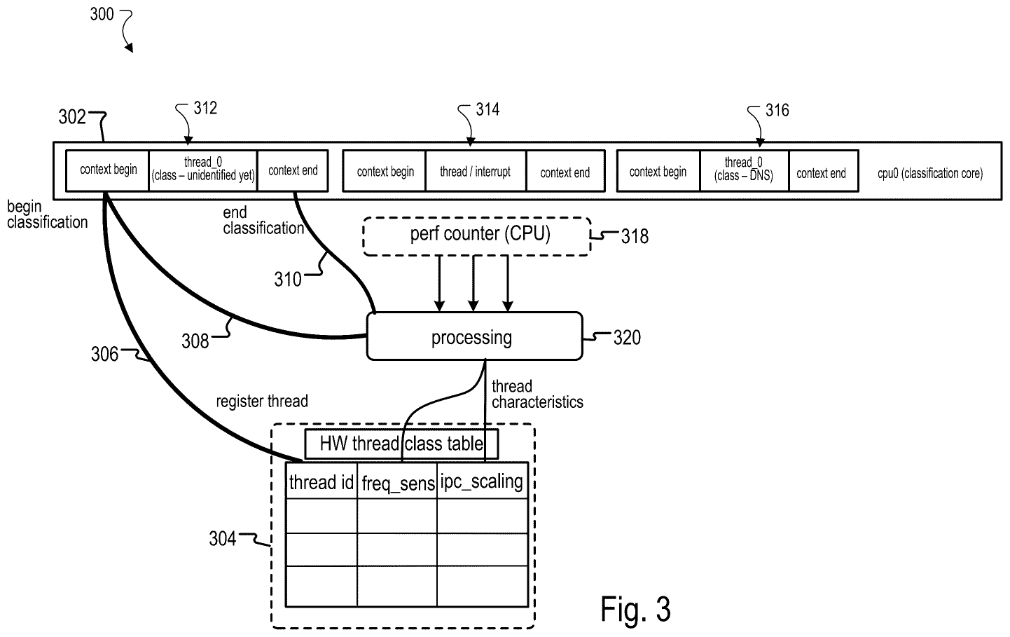

FIG. 3 illustrates an example timeline 300 of thread execution that includes a thread classification. The example timeline 300 includes a sequence of executable threads 302, in which each thread is executed on a processor. The example timeline 300 represents a sequence of three threads 312-316 that include tasks received by the processor 320 from an operating system or from another processor. In some implementations, classification tasks are distributed between multiple processors. In some implementations, the classification processor 320 also executes tasks related to thread execution. As an illustrative example, the example timeline 300 represents the sequence of executable threads 302 received by a single dedicated classification processor 320.

The classification processor 320 receives a first thread 312 that includes a context begin instruction, a sequence of tasks related to the first thread 312, and a context end instruction. The context begin instruction indicates a beginning of a context switch for the thread 312. In the example timeline 300, the context begin instruction indicates a beginning of a classification task for the thread 312. The context end instruction indicates a completion of the classification task for the thread 312.

In some implementations, the context begin instruction includes a write to a control status register (CSR) to trigger a classification task. In some implementations, the context end instruction includes a write to a CSR to end the classification task. The classification processor 320 executes operations associated with the classification task until a classification is valid or until it receives the context end instruction.

The beginning of the classification task, as indicated by the context begin instruction of the thread 312, initiates a first operation 306 to register the thread 312 in a hardware lookup table 304. A second operation 308 initiates the classification task to be executed by the classification processor 320. The processor 320 executes the tasks included in the thread 312. As the processor 320 executes the tasks, or in some cases, after the processor 320 executes the tasks, the processor 320 updates associated performance counters 318. In some implementations, a processor different from the processor 320 executes the tasks, and the processor 320 implements the classification task. The processor 320 processes the values of the associated performance counters 318 with a classifier model to determine thread characteristics, as described in relation to FIGS. 1 and 2. The thread characteristics are stored in the hardware lookup table 304. For example, as illustrated in the example hardware lookup table 304 of FIG. 3, each row of the hardware lookup table 304 includes a thread identifier and multiple thread characteristics, e.g., frequency sensitivity and IPC scaling. In some implementations, the processor 320 stores discrete classes (e.g., scales (s) or does not scale (dns)) in the hardware lookup table 304. In some implementation, the processor 320 stores continuous values in the hardware lookup table 304. In this example, a thread scheduler schedules the thread 312 to be executed on processor 320 (or some other processor) based on a default thread scheduling algorithm.

As previously described, the thread characteristics stored in the hardware lookup table 304 are accessible to an operating system that implements a thread scheduler. The thread scheduler can process the thread characteristics to determine an optimally-scheduled thread on a suitable processor.

The first thread 312 concludes with the context end instruction, which can indicate a thread switching event. In the example timeline 300, the context end instruction is initiated in order to processes a second thread 314 which is a thread interrupt instruction. Other examples could illustrate the second thread 314 as an additional classification task or a thread execution task. Similar to the first thread 312, the second thread 314 includes a context begin instruction, instructions to execute one or more tasks (e.g., a thread interrupt), and a context end instruction.

The example timeline 300 illustrates an execution of a third thread 316, which is a resumed execution of the first thread 312. The third thread 316 includes a context begin, which is indicative of an instruction to resume the execution of the first thread 312 from where it finished before the initiation of the second thread 314. However, because of the executed classification task that resulted from the execution of the first thread 312, the operating system tasked with scheduling the thread 316 can make a more optimal decision for scheduling the third thread 316 on a more appropriate processor. The thread 316 is characterized by a scaling class (e.g., does not scale), which the thread scheduler uses to optimally schedule the third thread 316. The optimal schedule of the third thread 316 can deviate from a decision based on the default thread scheduling algorithm.

The example timeline 300 illustrates a thread classification task which results in an optimally scheduled thread. In some cases, execution of a thread is paused and resumed, and the resumed execution can be performed on a processor different from an initial processor as determined by a default thread scheduling algorithm.

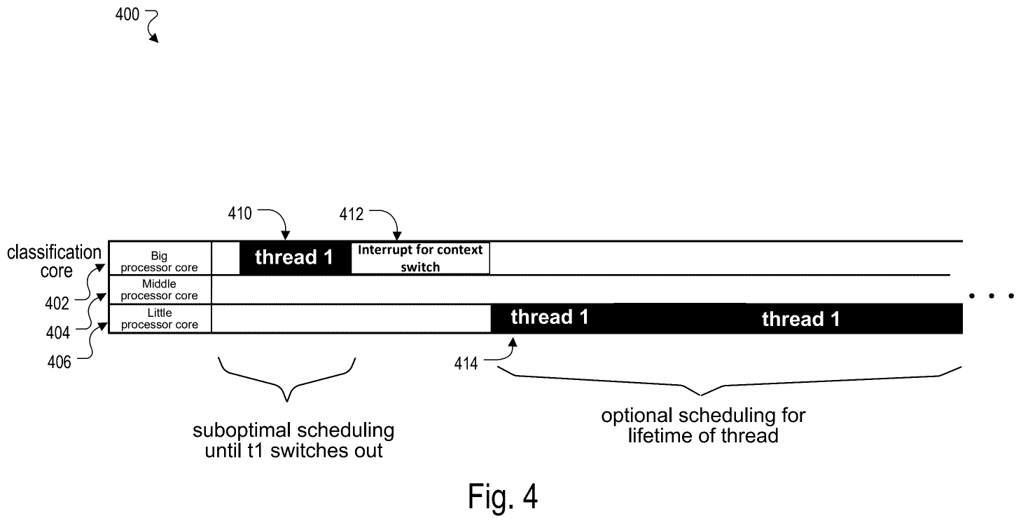

FIG. 4 illustrates an example thread scheduling implementation 400. The example implementation 400 includes an execution of threads by a system that includes three processors, (e.g., a big processor 402, a medium processor 404, and a little processor 406). The example thread scheduling implementation 400 considers the big processor 402 to be a classification processor, in which the big processor 402 executes instructions of a classifier model to determine a class of each thread, upon receiving an instruction to perform a thread classification.

The big processor 402 receives instructions to execute tasks of a first thread 410 according to an initial default scheduling decision determined by a thread scheduler executed as part of an operating system. The thread scheduler determines if existing context is present in a hardware lookup table pertaining to the first thread 410 (e.g., it checks the hardware lookup table to determine if a classification process has already been executed in relation to the first thread 410). If the hardware lookup table does not include context for the first thread 410, the thread scheduler schedules the first thread 410 to be executed by the big processor 402 based on the default scheduling algorithm. The big processor 402 executes the instructions of the first thread 410 and executes instructions according to the classifier model and stores the output thread characteristics in a hardware lookup table.

The example implementation 400 includes a second thread 412 (e.g., an IRQ or other thread) that causes the first thread 410 to switch out upon completing the classification task. Upon completing the execution of the second thread 412, the thread scheduler initiates a command to resume execution of the first thread 410. The thread scheduler first determines if existing context is present in the hardware lookup table for the first thread 410. In this case, the big processor 402 already performed the classification task in relation to the first thread 410, so the hardware lookup table includes context pertaining to the first thread 410 and associated thread characteristics. The thread scheduler accesses the thread characteristics in relation to the first thread 410 and determines an optimal thread scheduling decision that may from the default thread scheduling decision for the first thread 410. The example implementation 400 includes an optimal scheduling decision different from the default scheduling decision for the first thread 410, in which a second instruction 414 for thread execution is sent to the little processor 406 instead of the big processor 402. For the remaining instructions sent from the thread scheduler to the system that includes the processors 402-406, the first thread 410 is executed on the little processor 406, which is a more optimal scheduling decision in comparison to the default scheduling decision.

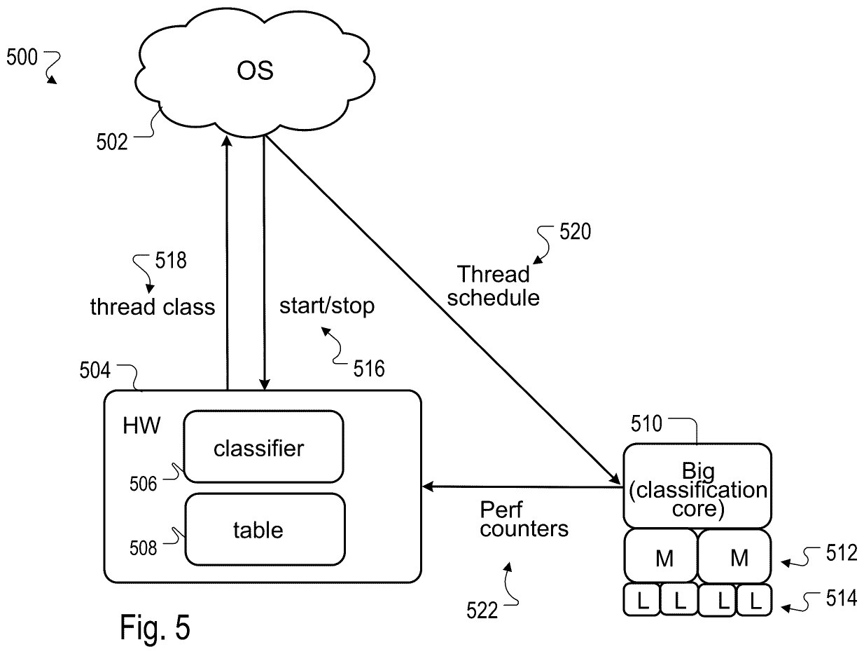

FIG. 5 illustrates an example system 500 for scheduling threads. The system 500 includes a hardware unit 504 with one or more processors 510. At least one processor of the processors 510 is configured to execute operations of a classifier model 506. The hardware unit 504 also includes at least one hardware lookup table 508. The hardware unit 504 is communicatively coupled to a software implementation of an operating system 502. For example, data path 516 enables a transmission of instructions from the operating system 502 to the hardware unit 504, in which the instructions are indicative of starting and stopping a classification process. Similarly, data path 520 enables a transmission of instructions from the operating system 502 to the processors of the hardware unit 504, in which the instructions are indicative of starting and stopping thread execution.

In some implementations, executable instructions associated with the operating system 502 are executed by one or more processors of the hardware unit 504. In some implementations, the executable instructions associated with the operating system 502 and the executable instructions associated with the classifier model 506 are executed by a common processor, distributed between multiple processors, or executed by distinct processors. In some implementations, a dedicated processor of the hardware unit 504 is responsible for executing the instructions associated with the classifier model 506.

The processors 510 of the hardware unit 504 include multiple processors of various sizes (e.g., a big processor 510, medium processors 512, and little processors 514). The example system 500 depicts the big processor 510 as a dedicated classification processor. In some implementations, the dedicated classification processor executes tasks associated with thread instructions in addition to executing classification tasks. In this example, the classifier model 506 is implemented as executable instructions by the big processor 510.

The operating system 502 executes operations of a thread scheduler. The thread scheduler determines a thread scheduling decision, in which the thread scheduler, via the operating system 502, issues an instruction for a particular processor (e.g., the big processor 510) to execute the tasks of a particular thread based on a default thread scheduling decision. In this case, the default thread scheduling decision is to execute the tasks associated with the particular thread on the big processor 510. The big processor 510 executes the tasks for a first time period. During or after the first time period, one or more values represented by performance counters 522 are processed by the classifier model 506 to determine one or more thread characteristics, in which the thread characteristics are stored in the hardware lookup table 508.

The thread scheduler determines a processor to execute instructions (e.g., tasks) associated with a particular thread. For each thread, the thread scheduler can query the hardware lookup table 508 to determine if the thread is represented in the data stored in the hardware lookup table 508 (e.g., determines if a classification task has already been executed in relation to the thread). If the particular thread is represented in data stored in the hardware lookup table 508, the thread scheduler can receive one or more associated thread characteristics, or a thread class 518, and determine an optimal scheduling decision for the thread. In other words, based on the stored thread characteristics (thread class 518), the thread scheduler can determine an optimal processor to execute the tasks represented by the thread. In some cases, the thread scheduler determines that the original default scheduling decision is already the optimal scheduling decision. In some other cases, the thread scheduler determines that a modified scheduling decision is optimal in relation to the default decision, and a new processor receives the instruction to execute tasks of the thread in future invocations.

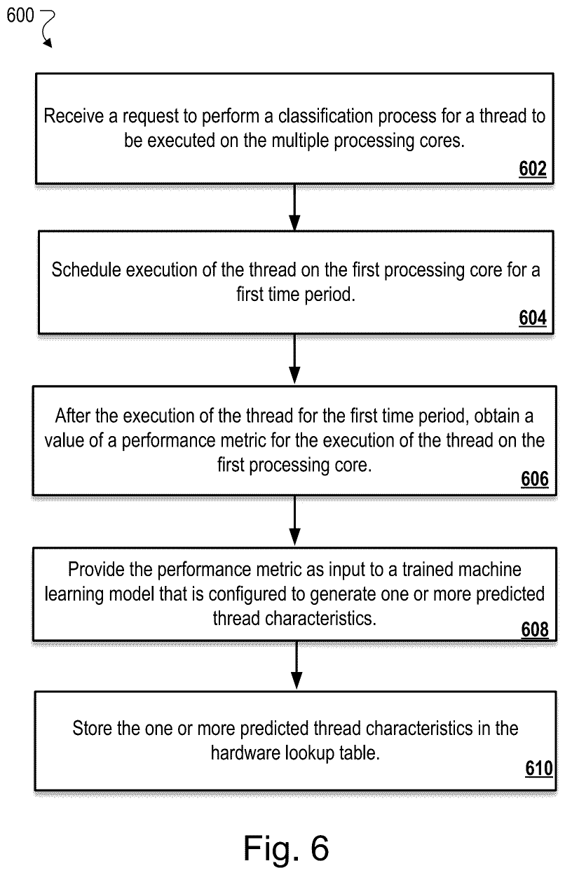

FIG. 6 is a flow diagram of an example process 600 for performing a thread classification. Process 600 is implemented or executed by a system with at least one hardware unit (e.g., the hardware unit 102). The descriptions of process 600 will reference the above mentioned system 100. In some examples, the steps or actions of process 600 are enabled by programmed software instructions, firmware instructions, or both. Each type of instruction may be stored in a non-transitory machine-readable storage device and is executable by one or more of the processors or other resources described in this specification.

The system receives (602) a request to perform a classification process for a thread to be executed on multiple processing cores. In some implementations, the classification process is implemented by one of the multiple processing cores. In some implementations, a dedicated processing core performs the classification process in addition to thread execution. In some implementations, the request is received by the hardware system that includes the multiple processing cores from an operating system.

The system schedules (604) execution of the thread on the first processing core for a first time period. In some implementations, the thread is executed on a first processing core until an end context instruction is received from the operating system to stop executing the thread. After the execution of the thread for the first time period, the system obtains (606) a value of a performance metric for the execution of the thread on the first processing core. In some implementations, multiple performance metrics are obtained. Performance metrics can include metrics associated with an execution of the thread on the first processor. For example, workload (e.g., clock cycles), IPC, whether the processor bound by compute resources or memory resources, wake-up overhead, floating-point/integer instructions, and thermal scaling properties.

The system provides (608) the performance metric as input to a trained machine learning model, e.g., a classifier model, that is configured to generate one or more predicted thread characteristics. The system stores (610) one or more predicted thread characteristics (thread attributes) in a hardware lookup table. The machine learning model, implemented on one of the processors of the multiple processing cores, can access the predicted thread characteristics by querying the hardware lookup table. In some implementations, the trained machine learning model is a classifier model.

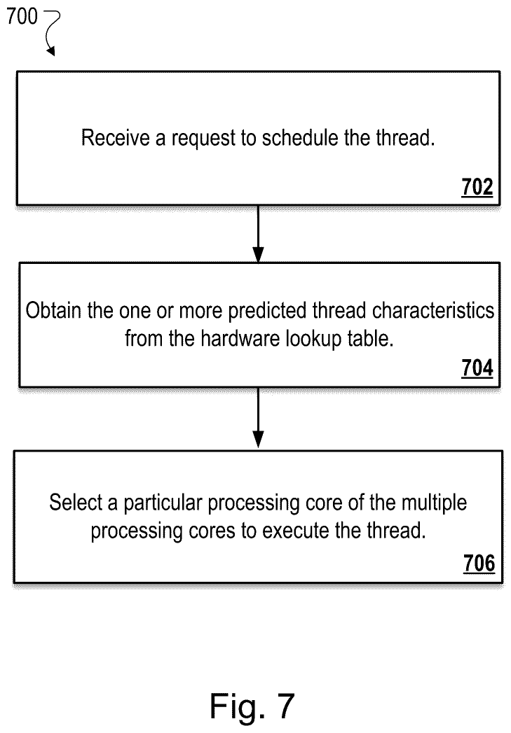

FIG. 7 is a flow diagram of an example process 700 for scheduling threads. Process 700 is implemented or executed by a system with at least one hardware unit (e.g., the hardware unit 102). The descriptions of process 700 will reference the above mentioned system 100. In some examples, the steps or actions of process 700 are enabled by programmed software instructions, firmware instructions, or both. Each type of instruction may be stored in a non-transitory machine-readable storage device and is executable by one or more of the processors or other resources described in this specification.

The system receives (702) a request to schedule a thread. In some implementations, the system receives (702) the request to schedule the thread from an operating system through a communication interface that couples software resources to hardware resources. In some implementations, the request to schedule the thread is a result of a decision determined by a thread scheduler based on a default thread scheduling algorithm.

The system obtains (704) one or more predicted thread characteristics (attributes) from the hardware lookup table. The predicted thread characteristics are associated with the thread. In some implementations, the thread is associated with a particular thread identifier that is represented in the hardware lookup table. If the particular thread identifier is represented in the hardware lookup table, the system can obtain (704) the one or more predicted thread characteristics in order to select (706) a particular processing core of the multiple processing cores to execute the thread. If the particular thread identifier is not represented in the hardware lookup table, the system can perform the operations of process 600 to determine the one or more thread characteristics and populate an associated record in the hardware lookup table for future instantiations to access.

FIG. 8 is an example graphical representation 800 of computational scaling characteristics of threads.

The graphical representation 800 includes a horizontal axis 804 that represents a processor size (e.g., a big processor, middle processor, and little processor). A vertical axis 802 includes a performance metric, IPC (inter-process communication), which is representative of an amount of data transferred between computing resources to facilitate process collaboration. Multiple example threads 806, each associated with example applications are depicted in the graphical representation 800.

A first example thread 810 demonstrates a thread that does not scale with larger processors. This feature is illustrated by a “bend” in the relationship, in which the IPC does not increase between the middle processor and the big processor. In other words, the example thread 810 does not benefit from being executed on the big processor in relation to the middle processor. Therefore, an optimal scheduling decision is to schedule the thread 810 to be executed on the middle processor to unnecessary energy consumption and to allow the big processor to execute tasks associated with threads that can benefit from the larger processing power, e.g., example thread 812.

The example thread 812 demonstrates a linear scaling of IPC as a function of processor size. In other words, as the processor size increases (from little to big), the IPC (example performance metric) increases linearly. An optimal scheduling decision in relation to the example thread 812 is to execute the example thread 812 on the big processor.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (general purpose graphics processing unit).

Computers suitable for the execution of a computer program, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims.

In addition to the embodiments described above, the following embodiments are also innovative:

Embodiment 1 is a system comprising:
a plurality of processing cores;
a hardware lookup table;
one or more non-transitory computer storage media storing instructions that when executed by a first processing core of the plurality of processing cores causes the first processing core to perform operations comprising:
receiving a request to perform a classification process for a thread to be executed on the plurality of processing cores;
scheduling execution of the thread on the first processing core for a first time period;
after the execution of the thread for the first time period, obtaining a value of a performance metric for the execution of the thread on the first processing core;
providing the performance metric as input to a trained machine learning model that is configured to generate one or more predicted thread characteristics; and
storing the one or more predicted thread characteristics in the hardware lookup table.

Embodiment 2 is the system of embodiment 1, wherein a second processing core is configured to execute instructions of an operating system for the plurality of processing cores to perform operations comprising:
receiving a request to schedule the thread;
obtaining the one or more predicted thread characteristics from the hardware lookup table based on a thread identifier; and
selecting a particular processing core of the plurality of processing cores to execute the thread based on the one or more predicted thread characteristics.

Embodiment 3 is the system of embodiment 1, wherein the classification process includes implementing a machine learning model, wherein the machine learning model is trained offline.

Embodiment 4 is the system of embodiment 1, wherein the value of the performance metric is based on a performance counter.

Embodiment 5 is the system of embodiment 1, wherein a dedicated processing core performs the classification process.

Embodiment 6 is the system of embodiment 1, wherein the plurality of processing cores include processing cores of multiple sizes, wherein each size corresponds to a different processing capability.

Embodiment 7 is the system of embodiment 2, further comprising selecting a particular processing core of the plurality of processing cores to execute the thread, wherein the selecting is based on a processing core size and a performance metric.

Embodiment 8 is the system of embodiment 1, wherein each row of the hardware lookup table includes a thread identifier and a plurality of thread characteristics.

Embodiment 9 is the system of embodiment 1, wherein an execution duration of the thread on the first processing core for the first time period is controlled by a register value, the register value configured by a third processing core, the third processing core configured to execute instructions of an operating system.

Embodiment 10 is the system of embodiment 1, wherein the operations further comprise obtaining one or more thread characteristics from the hardware lookup table based on a thread identifier prior to scheduling execution of the thread, the one or more thread characteristics determined during a previous execution of the thread and based on the one or more obtained thread characteristics, scheduling execution of the thread on a corresponding processing core.

Embodiment 11 is a method performed by a first processing core of a plurality of processing cores, the method comprising:
receiving a request to perform a classification process for a thread to be executed on the plurality of processing cores;
scheduling execution of the thread on the first processing core for a first time period;
after the execution of the thread for the first time period, obtaining a value of a performance metric for the execution of the thread on the first processing core;
providing the performance metric as input to a trained machine learning model that is configured to generate one or more predicted thread characteristics; and
storing the one or more predicted thread characteristics in a hardware lookup table.

Embodiment 12 is the method of embodiment 11, wherein a second processing core is configured to execute instructions of an operating system for the plurality of processing cores to perform operations comprising:
receiving a request to schedule the thread;
obtaining the one or more predicted thread characteristics from the hardware lookup table based on a thread identifier; and
selecting a particular processing core of the plurality of processing cores to execute the thread based on the one or more predicted thread characteristics.

Embodiment 13 is the method of embodiment 11, wherein the classification process includes implementing a machine learning model, wherein the machine learning model is trained offline.

Embodiment 14 is the method of embodiment 11, wherein the value of the performance metric is based on a performance counter.

Embodiment 15 is the method of embodiment 11, wherein a dedicated processing core performs the classification process.

Embodiment 16 is the method of embodiment 11, wherein the plurality of processing cores include processing cores of multiple sizes, wherein each size corresponds to a different processing capability.

Embodiment 17 is the method of embodiment 11, further comprising selecting a particular processing core of the plurality of processing cores to execute the thread, wherein the selecting is based on a processing core size and a performance metric.

Embodiment 18 is the method of embodiment 11, wherein each row of the hardware lookup table includes a thread identifier and a plurality of thread characteristics.

Embodiment 19 is the method of embodiment 11, wherein an execution duration of the thread on the first processing core for the first time period is controlled by a register value, the register value configured by a third processing core, the third processing core configured to execute instructions of an operating system.

Embodiment 20 is the method of embodiment 11, further comprising obtaining one or more thread characteristics from the hardware lookup table based on a thread identifier prior to scheduling execution of the thread, the one or more thread characteristics determined during a previous execution of the thread and based on the one or more obtained thread characteristics, scheduling execution of the thread on a corresponding processing core.

What is claimed is:

1. A system comprising:
a plurality of processing cores;
a hardware lookup table;
one or more non-transitory computer storage media storing instructions that when executed by a first processing core of the plurality of processing cores causes the first processing core to perform operations comprising:
receiving a request to perform a classification process for a thread to be executed on the plurality of processing cores;
scheduling execution of the thread on the first processing core for a first time period;
after the execution of the thread for the first time period, obtaining a value of a performance metric for the execution of the thread on the first processing core;
providing the performance metric as input to a trained machine learning model that is configured to generate one or more predicted thread characteristics; and
storing the one or more predicted thread characteristics in the hardware lookup table.

2. The system of claim 1, wherein a second processing core is configured to execute instructions of an operating system for the plurality of processing cores to perform operations comprising:
receiving a request to schedule the thread;
obtaining the one or more predicted thread characteristics from the hardware lookup table based on a thread identifier; and
selecting a particular processing core of the plurality of processing cores to execute the thread based on the one or more predicted thread characteristics.

3. The system of claim 1, wherein the classification process includes implementing a machine learning model, wherein the machine learning model is trained offline.

4. The system of claim 1, wherein the value of the performance metric is based on a performance counter.

5. The system of claim 1, wherein a dedicated processing core performs the classification process.

6. The system of claim 1, wherein the plurality of processing cores include processing cores of multiple sizes, wherein each size corresponds to a different processing capability.

7. The system of claim 2, further comprising selecting a particular processing core of the plurality of processing cores to execute the thread, wherein the selecting is based on a processing core size and a performance metric.

8. The system of claim 1, wherein each row of the hardware lookup table includes a thread identifier and a plurality of thread characteristics.

9. The system of claim 1, wherein an execution duration of the thread on the first processing core for the first time period is controlled by a register value, the register value configured by a third processing core, the third processing core configured to execute instructions of an operating system.

10. The system of claim 1, wherein the operations further comprise:
obtaining one or more thread characteristics from the hardware lookup table based on a thread identifier prior to scheduling execution of the thread, the one or more thread characteristics determined during a previous execution of the thread; and
based on the one or more obtained thread characteristics, scheduling execution of the thread on a corresponding processing core.

11. A method performed by a first processing core of a plurality of processing cores, the method comprising:
receiving a request to perform a classification process for a thread to be executed on the plurality of processing cores;
scheduling execution of the thread on the first processing core for a first time period;
after the execution of the thread for the first time period, obtaining a value of a performance metric for the execution of the thread on the first processing core;
providing the performance metric as input to a trained machine learning model that is configured to generate one or more predicted thread characteristics; and
storing the one or more predicted thread characteristics in a hardware lookup table.

12. The method of claim 11, wherein a second processing core is configured to execute instructions of an operating system for the plurality of processing cores to perform operations comprising:
receiving a request to schedule the thread;
obtaining the one or more predicted thread characteristics from the hardware lookup table; and
selecting a particular processing core of the plurality of processing cores to execute the thread based on the one or more predicted thread characteristics.

13. The method of claim 11, wherein the classification process includes implementing a machine learning model, wherein the machine learning model is trained offline.

14. The method of claim 11, wherein the value of the performance metric is based on a performance counter.

15. The method of claim 11, wherein a dedicated processing core performs the classification process.

16. The method of claim 11, wherein the plurality of processing cores include processing cores of multiple sizes, wherein each size corresponds to a different processing capability.

17. The method of claim 12, further comprising selecting a particular processing core of the plurality of processing cores to execute the thread, wherein the selecting is based on a processing core size and a performance metric.

18. The method of claim 11, wherein each row of the hardware lookup table includes a thread identifier and a plurality of thread characteristics.

19. The method of claim 11, wherein an execution duration of the thread on the first processing core for the first time period is controlled by a register value, the register value configured by a third processing core, the third processing core configured to execute instructions of an operating system.

20. The method of claim 11, further comprising:
obtaining one or more thread characteristics from the hardware lookup table based on a thread identifier prior to scheduling execution of the thread, the one or more thread characteristics determined during a previous execution of the thread; and
based on the one or more obtained thread characteristics, scheduling execution of the thread on a corresponding processing core.
